(19) United States
(12) Patent Application Publication
(10) Pub. No.: US 2015/0083825 A1
(43) Pub. Date: Mar. 26, 2015

(54) SURFACE TREATMENT SYSTEM AND METHOD

(71) Applicant: GEORGE GRANVILE SCHERICH, COLLIERS, WV (US)

(72) Inventor: GEORGE GRANVILE SCHERICH, COLLIERS, WV (US)

(21) Appl. No.: 14/496,067

(22) Filed: Sep. 25, 2014

Related U.S. Application Data
(60) Provisional application No. 61/882,182, filed on Sep. 25, 2013.

(51) Int. Cl. B05B 7/04; B05B 7/24; B05B 1/06; B05B 7/12; B65D 83/60; B05D 1/02

(52) U.S. Cl. CPC B05B 7/0416; B65D 83/60; B05D 1/02; B05B 1/06; B05B 7/129; B05B 7/2478; B05B 7/2464
USPC 239/337; 427/421.1

(57) ABSTRACT

A surface treatment system includes a pressure generator structured to generate air pressure; a spray head assembly coupled to the pressure generator; and a hopper coupled to the spray head assembly and structured to hold surface treatment material, the hopper including an extended portion disposed at a top front portion of the hopper that raises a front top edge of the hopper to be higher than a rear top edge of the hopper, wherein the hopper is configured to provide the surface treatment material to the spray head assembly and the spray head assembly is configured to use the air pressure to spray the surface treatment material onto a surface.

### CROSS-REFERENCE TO RELATED APPLICATIONS

This application claims priority under 35 U.S.C. §119(e) from U.S. provisional patent application No. 61/882,182, entitled “Surface Treatment System and Method” and filed on Sep. 25, 2013, the contents of which are incorporated herein by reference.

### BACKGROUND

1. Field

The disclosed concept relates generally to surface treatment systems and methods, and, more particularly, to a system and/or method for spraying treatment on a surface.

2. Background

Many surface treatments, and in particular, many deck treatments such as Rust-Oleum® Deck and Concrete Restore™ (manufactured by Rust-Oleum® Corporation) are designed to be applied to a surface with a roller applicator. However, applying a surface treatment using a roller applicator is a relatively time consuming process.

It would thus be desirable to provide an improved surface treatment system and/or method that overcomes this and other shortcomings in the relevant art.

### SUMMARY OF THE INVENTION

In one embodiment, a surface treatment system includes a pressure generator structured to generate air pressure; a spray head assembly coupled to the pressure generator; and a hopper coupled to the spray head assembly and structured to hold surface treatment material, the hopper including an extended portion disposed at a top front portion of the hopper that raises a front top edge of the hopper to be higher than a rear top edge of the hopper, wherein the hopper is configured to provide the surface treatment material to the spray head assembly and the spray head assembly is configured to use the air pressure to spray the surface treatment material onto a surface.

In another embodiment, a sprayer for treating a surface includes a spray head assembly structured to receive air pressure; and a hopper coupled to the spray head assembly and structured to hold surface treatment material, the hopper including tended portion disposed at a top front portion of the hopper that raises a front top edge of the hopper to be higher than a rear top edge of the hopper, wherein the hopper is configured to provide the surface treatment material to the spray head assembly and the spray head assembly is configured to use the air pressure to spray the surface treatment material onto a surface.

In another embodiment, a method of applying treatment to a surface includes providing a sprayer including a spray head assembly structured to receive air pressure and a hopper coupled to the spray head assembly and structured to hold surface treatment material, the hopper including an extended portion disposed at a top front portion of the hopper that raises a front top edge of the hopper to be higher than a rear top edge of the hopper, wherein the hopper is configured to provide the surface treatment material to the spray head assembly and the spray head assembly is configured to use the air pressure to spray the surface treatment material onto a surface; providing air pressure to the sprayer; and spraying the surface treatment material on the surface using the sprayer.

### BRIEF DESCRIPTION OF THE DRAWINGS

A further understanding of the disclosed and claimed concept can be gained from the following Description when read in conjunction with the accompanying drawing in which:

FIG. 1 is a schematic diagram of a surface treatment system in accordance with an embodiment of the disclosed concept;

FIG. 2 is a front view of a hopper used with a surface treatment system in accordance with an embodiment of the disclosed concept;

FIG. 3 is a schematic diagram of a surface treatment system in use in accordance with an embodiment of the disclosed concept; and

FIGS. 4A and 4B are front views of nozzles used with a surface treatment system in accordance with embodiments of the disclosed concept.

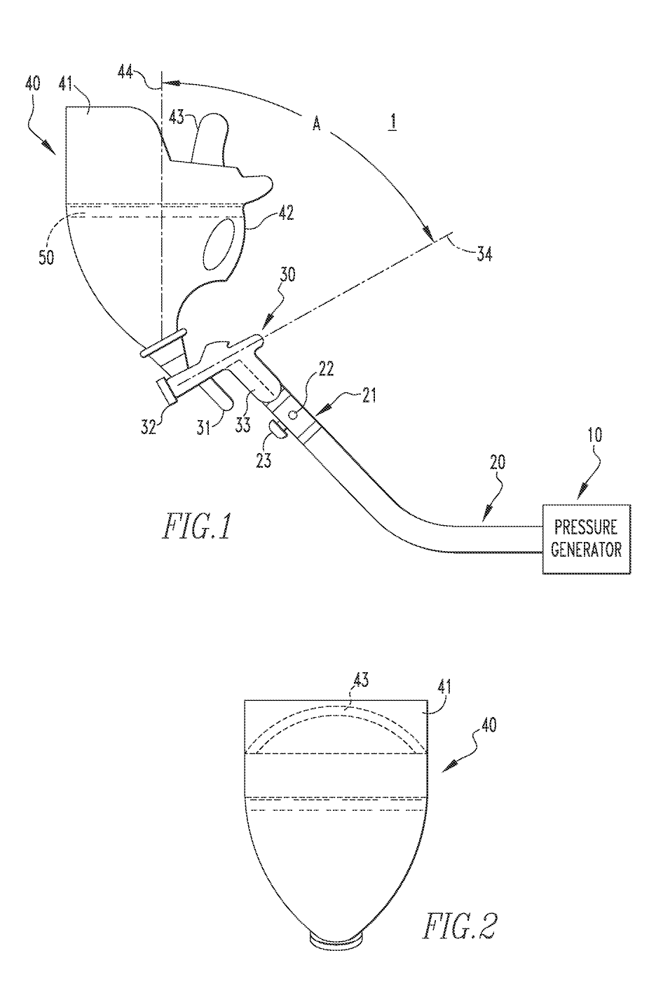

Similar numerals refer to similar parts throughout the specification.

### DESCRIPTION

Directional phrases used herein, such as, for example, left, right, front, back, top, bottom and derivatives thereof, relate to the orientation of the elements shown in the drawings and are not limiting upon the claims unless expressly recited therein.

Referring to FIG. 1, a schematic diagram of a surface treatment system 1 in accordance with an embodiment of the disclosed concept is shown. The surface treatment system 1 includes a pressure generator 10, a conduit 20, a spray head assembly 30, and a hopper 40. Collectively, the spray head assembly 30 and the hopper 40 form a sprayer.

The pressure generator 10 generates air pressure. The pressure generator 10 is coupled to the conduit 20 and supplies the generated air pressure to the conduit 20. Any suitable device for generating air pressure (e.g., without limitation, an air compressor) may be employed as the pressure generator 10. In some embodiments of the disclosed concept, the pressure generator 10 is capable of generating at least 60 psi of pressure. Furthermore, in some embodiments of the disclosed concept, the pressure generator 10 is configured to provide a relatively constant pressure of about 60 psi. In some other embodiments of the disclosed concept, the pressure generator 10 is capable of generating at least 100 psi of pressure. In some of other embodiments of the disclosed concept, the pressure generator 10 is capable of generating about 160 psi of pressure.

The conduit 20 couples the pressure generator 10 to the spray head assembly 30 via a pressure regulator 21. The pressure regulator 22 includes an adjustable valve 22 that can be operated to limit the amount of pressure provided to the spray head assembly 30. The pressure regulator 21 also includes a gauge 23. The gauge 23 allows a user to visibly verify the amount of pressure that is being provided to the spray head assembly 30 by the pressure generator 10. It should be noted that the pressure regulator 21 may be omitted without departing from the scope of the disclosed concept.

The hopper 40 is disposed on top of the spray head assembly 30 and is configured to hold surface treatment material 50. The surface treatment material 50 is fed from the hopper 40 to the spray head assembly 30 where it is then sprayed out of a nozzle 32 of the spray head assembly 30 using the air pressure provided by the pressure generator 10.

The spray head assembly 30 includes a trigger 31 to control the spraying. Depressing the trigger 31 causes more air pressure to be used to spray the surface treatment material and thus allows more surface treatment material 50 to be sprayed out of the nozzle 32. However, if the trigger 31 is depressed too far, too much surface treatment material 50 can spray at once leading to undesirable effects such as spattering. To reduce or eliminate such problems, the spray head assembly 30 includes an extended grip portion 33 disposed behind the trigger 31. It is contemplated that the extended grip portion 33 may be integrated into the grip of the spray head assembly 30 in some embodiments of the disclosed concept. It is also contemplated that the extended grip portion 33 may be embodied as a spacer that is removable from the grip and may be interchanged with different sized spacers. The extended grip portion 33 is operable to limit the amount the trigger 31 may be depressed, and thus limit the amount of surface treatment material 50 that may be sprayed at once.

Referring to FIG. 4A, in some embodiments of the disclosed concept, the nozzle 32 includes a circular orifice 34 that allows the surface treatment material 50 to pass through it, The circular orifice 34 has a generally circular shape. If the circular orifice 34 is too large, too much surface treatment material 50 will pass through it at once, and if it is too small, not enough surface treatment material 50 will pass through it. In some embodiments of the disclosed concept, the orifice 34 has a diameter in a range of about 20-40 mm. In some other embodiments of the disclosed concept, the orifice 34 has a diameter of about 30 mm.

Referring to FIG. 4B, in some other embodiments of the disclosed concept, the nozzle 32 includes an oblong orifice 34. The oblong orifice 34′ has a slat shape. In some embodiments of the disclosed concept, the length of the minor axis of the oblong orifice 34′ is within a range of about 20-40 mm. In some other embodiments of the disclosed concept, the length of the minor axis of the oblong orifice 34′ is about 30 mm.

Referring back to FIG. 1, the front side of the hopper 40 includes an extended portion 41. The extended portion 41 functions to increase the height of the front side of the hopper 40. The increased height provided by the extended portion 41 of the hopper 40 makes it more difficult to spill the surface treatment material 50 out of the front side of the hopper 40. In particular, when a user of the surface treatment system 1 leans forward with the spray head assembly 30 and hopper 40, such as one might do when applying surface treatment to a deck, there is a risk of spilling surface material 50 out of the front side of the hopper 40. However, the extended portion 41 of the front side of the hopper 40 reduces this risk.

The rear side of the hopper 40 includes a rear handle 42 and the top side of the hopper 40 includes a top handle 43. The rear handle 42 and the top handle 43 provide a user with places to hold the hopper 40 to provide it with more stability. Providing both the rear handle 42 and the top handle 43 allow the user to choose the most comfortable handle to hold the hopper 40 with. It is contemplated that the rear handle 42, the top handle 43, or both may be omitted without departing from the scope of the disclosed concept.

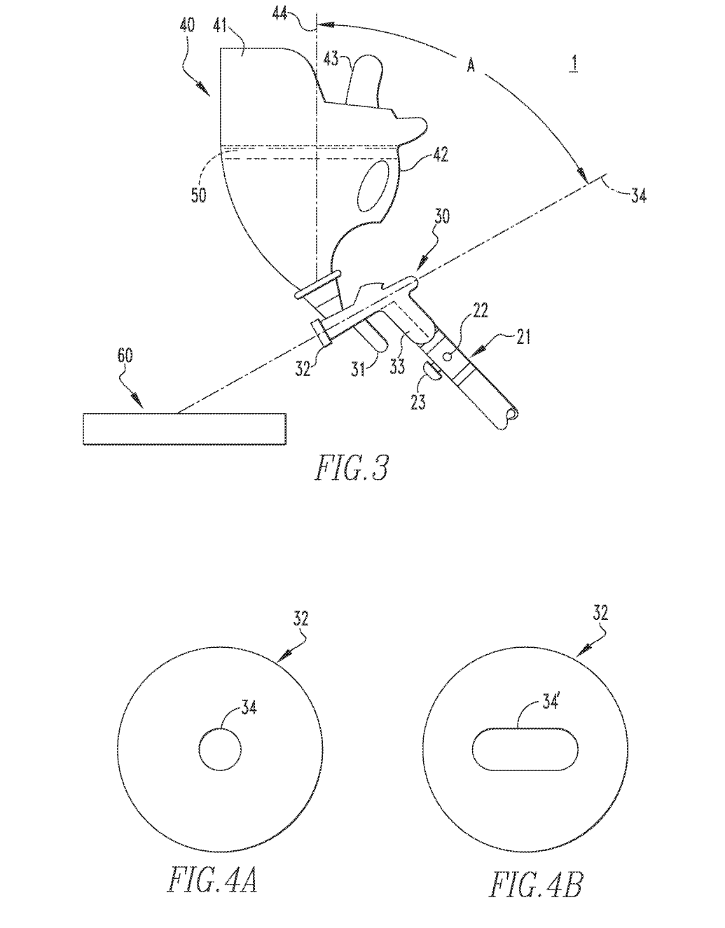

A center line 34 of the spray head assembly 30 is shown in FIG. 1. The center line 34 of the spray head assembly 30 passes through the nozzle 32 in the direction that the spray head assembly 30 sprays the surface treatment material 50. A center line 44 of the hopper 40 is also shown in FIG. 1. The center line 40 of the hopper 40 passes vertically through the hopper 40. When the center line 44 of the hopper 40 is arranged vertically, the upper edge of the hopper 40 is arranged horizontally. The center line 34 of the spray head assembly 30 and the center line 44 of the hopper 40 are arranged at an angle A with respect to each other such that the spray head assembly 30 sprays in a downward direction when the center line 44 of the hopper 40 is arranged vertically. This allows a user of the surface treatment system 1 to comfortable spray a surface 60 (see FIG. 3) such as a deck or driveway comfortably and without fear of spilling the surface treatment material 50 out of the hopper 40. In some embodiments of the disclosed concept, angle A is within a range of about 20-70 degrees. It is also contemplated that the surface treatment system 1 may be used to apply surface treatment material to vertical or angled surfaces as well.

in some embodiments of the disclosed concept, a Rust-Oleum® Restore™ product such as Rust-Oleum® Deck and Concrete Restore™ is used as the surface treatment material 50. Rust-Oleum® Corporation instructs users of Rust-Oleum® Deck and Concrete Restore™ to apply it using a proprietary Restore™ Roller. However, the surface treatment system 1 of the present application applies Rust-Oleum® Deck and Concrete Restore™ to a surface more quickly and more effectively. For example, the inventor of the present application has found that the Rust-Oleum® Deck and Concrete Restore™ cannot be applied to vertical surfaces using a roller because it runs before drying. However, the inventor of the present application has discovered that spraying Rust-Oleum® Deck and Concrete Restore™ with the surface treatment system 1 allows it to be applied to vertical surfaces because the spraying causes it to dry more quickly, thus preventing it from running.

Rust-Oleum® Deck and Concrete Restore™ is a relatively thick material, and thus one having ordinary skill in the art would generally determine that it should be applied using a brush or roller. In contrast with this viewpoint, the inventor of the present application has found that the surface treatment system 1 is capable of effectively applying the product. Moreover, the inventor has found that using relatively high r pressure in the surface treatment system 1 effectively applies the product. For example, in some embodiments of the disclosed concept, an air pressure of about 60 psi or more is provided to the spray head assembly 30. In other embodiments, an air pressure of about 100 psi or more is provided to the spray head assembly 30. In yet other embodiments, an air pressure between 100 and 200 psi is provided to the spray head assembly 30. In contrast, many spray guns used for painting recommend using an air pressure below 60 psi, and high volume low pressure (HVLP) spray guns recommend using an air pressure below 10 psi.

While using the surface treatment system 1 with Rust-Oleum® Deck and Concrete Restore™ to treat a deck or another similar surface is one application for the disclosed concept, it will be appreciated by those having ordinary skill in the art that the disclosed concept is not limited thereto. It will be appreciated by those having ordinary skill in the art that the surface treatment system 1 may he adapted to use a variety of different surface treatment materials without departing from the scope of the disclosed concept. It will also be appreciated by those having ordinary skill in the art that the surface treatment system 1 may also be adapted for use on a variety of different types of surfaces, as well as different orientations of surfaces (e.g., vertical, horizontal, angled, etc.), without departing from the scope of the disclosed concept.

Although the foregoing discussion has presented specific embodiments, persons skilled in the art will recognize that changes may be made in form and detail without departing from the spirit and scope of the embodiments to achieve similar functionality and utility to the exemplary embodiments disclosed herein. Moreover, it should be appreciated that features from a particular embodiment may be implemented in another embodiment disclosed herein to achieve a desired functionality. Accordingly, the specific embodiments described herein should be understood as examples and not limiting the scope of the disclosure.

What is claimed is:

1. A surface treatment system comprising:
a pressure generator structured to generate air pressure;
a spray head assembly coupled to the pressure generator; and
a hopper coupled to the spray head assembly and structured to hold surface treatment material, the hopper including an extended portion disposed at a top front portion of the hopper that raises a front top edge of the hopper to be higher than a rear top edge of the hopper,
wherein the hopper is configured to provide the surface treatment material to the spray head assembly and the spray head assembly is configured to use the air pressure to spray the surface treatment material onto a surface.

2. The surface treatment system of claim 1, wherein the spray head assembly includes a nozzle having an orifice through which the surface treatment material is sprayed; and
wherein the orifice has one of a circular shape and an oblong shape.

3. The surface treatment system of claim 2, wherein the orifice has a circular shape having a diameter within a range of about 20 mm to about 40 mm.

4. The surface treatment system of claim 2, wherein the orifice has an oblong shape with a minor axis thereof having a length within a range of about 20 mm to about 40 mm.

5. The surface treatment system of claim 1, wherein the spray head assembly includes a trigger that can be depressed to control an amount of air pressure that the spray head assembly uses to spray the surface treatment material; and wherein the spray head assembly includes an extended grip disposed behind the trigger so as to limit an amount the trigger can depress.

6. The surface treatment system of claim 5, wherein the extended grip is a removable spacer.

7. The surface treatment system of claim 1, wherein the hopper includes at least one of a rear handle disposed on a rear portion of the hopper and a top handle disposed on a top portion of the hopper.

8. The surface treatment system of claim 1, wherein a center line of the hopper and a center line of the spray head assembly are disposed at an angle with respect to each other; wherein the angle is within a range of about 20 degrees to about 70 degrees.

9. The surface treatment system of claim 1, wherein the pressure generator is structured to generate at least about 60 psi of air pressure.

10. The surface treatment system of claim 1, further comprising:
a conduit disposed between the pressure generator and the spray head assembly, wherein the conduit is structured to communicate the air pressure from the pressure generator to the spray head assembly.

11. The surface treatment system of claim 1, further comprising:
a valve assembly coupled to the spray head assembly, wherein the valve assembly includes an air pressure gauge structured to indicate an amount of air pressure provided to the spray head assembly and a regulator valve structured to limit an amount of air pressure provided to the spray head assembly.

12. A sprayer for treating a surface, the sprayer comprising:
a spray head assembly structured to receive air pressure; and
a hopper coupled to the spray head assembly and structured to hold surface treatment material, the hopper including an extended portion disposed at a top front portion of the hopper that raises a front top edge of the hopper to be higher than a rear top edge of the hopper,
wherein the hopper is configured to provide the surface treatment material to the spray head assembly and the spray head assembly is configured to use the air pressure to spray the surface treatment material onto a surface.

13. The sprayer of claim 12, wherein the spray head assembly includes a nozzle having an orifice through which the surface treatment material is sprayed; and wherein the orifice has one of a circular shape and an oblong shape.

14. The sprayer of claim 13, wherein the orifice has a circular shape having a diameter within a range of about 20 mm to about 40 mm.

15. The sprayer of claim 13, wherein the orifice has an oblong shape with a minor axis thereof having a length within a range of about 20 mm to about 40 mm.

16. The sprayer of claim 12, wherein the spray head assembly includes a trigger that can be depressed to control an amount of air pressure that the spray head assembly uses to spray the surface treatment material; and wherein the spray head assembly includes an extended grip disposed behind the trigger so as to limit an amount the trigger can depress.

17. The sprayer of claim 16, wherein the extended grip is a removable spacer.

18. The sprayer of claim 12, wherein the hopper includes at least one of a rear handle disposed on a rear portion of the hopper and a top handle disposed on a top portion of the hopper.

19. The sprayer of claim 12, wherein a center line of the hopper and a center line of the spray head assembly are disposed at an angle with respect to each other; wherein the angle is within a range of about 20 degrees to about 70 degrees.

20. A method of applying treatment to a surface, the method comprising:
providing a sprayer including a spray head assembly structured to receive air pressure and a hopper coupled to the spray head assembly and structured to hold surface treatment material, the hopper including an extended portion disposed at a top front portion of the hopper that raises a front top edge of the hopper to be higher than a rear top edge of the hopper, wherein the hopper is configured to provide the surface treatment material to the spray head assembly and the spray head assembly is configured to use the air pressure to spray the surface treatment material onto a surface;
providing air pressure to the sprayer; and
spraying the surface treatment material on the surface using the sprayer.
